(19) United States
(12) Patent Application Publication
(10) Pub. No.: US 2024/0402495 A1
(43) Pub. Date: Dec. 5, 2024

(54) Waveguide-Based Eye Illumination

(71) Applicant: Apple Inc., Cupertino, CA (US)

(72) Inventor: Pushkar Pandit, San Jose, CA (US)

(21) Appl. No.: 18/691,014

(22) PCT Filed: Sep. 1, 2022
(86) PCT No.: PCT/US2022/042339

§ 371 Date: Mar. 11, 2024

Related U.S. Application Data
(60) Provisional application No. 63/246,624, filed on Sep. 21, 2021.

(51) Int. Cl. G02B 27/01; F21V 8/00; G02B 27/00

(52) U.S. Cl. CPC G02B 27/0172; G02B 6/001; G02B 27/0093; G02B 27/0176; G02B 2027/0138; G02B 2027/0178

(57) ABSTRACT

In one implementation, a device includes a frame to mount the device to a head. The device includes a light source, coupled to the frame, to generate light. The device includes a waveguide, optically coupled to the light source, to redirect the light to emit in a first direction from a plurality of leakage points, wherein, when the device is mounted to the head, the light is emitted in the first direction towards an eye to illuminate the eye.

### CROSS-REFERENCE TO RELATED APPLICATIONS

This application claims priority to U.S. Provisional Patent App. No. 63/246,624, filed on Sep. 21, 2021, which is hereby incorporated by reference in its entirety.

### TECHNICAL FIELD

The present disclosure generally relates to glasses including a light source which, when worn by a user, illuminates at least one eye of the user.

### BACKGROUND

Images of the eye of a user of a head-mounted device can be used to determine an identity of the user, determine a gaze direction of the user, or for other purposes. However, proper illumination of the eye typically involves multiple light sources, significantly increasing costs, adding heat, and draining power of the head-mounted device.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a front view of glasses worn by a user according to various implementations.

FIG. 2 illustrates a rear view of an eyepiece including an illumination system to illuminate the eye of a user according to a first implementation.

FIG. 3 illustrates a rear view of an eyepiece including an illumination system to illuminate the eye of a user according to a second implementation.

FIG. 4 illustrates a cross-sectional view of an illumination system in accordance with a first implementation.

FIG. 5 illustrates a cross-sectional view of an illumination system in accordance with a second implementation.

FIG. 6 illustrates a cross-sectional view of an illumination system in accordance with a third implementation.

FIG. 7 illustrates a functional block diagram of a device in accordance with some implementations.

FIG. 8 is a flowchart representation of a method of illuminating the eye of a user in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for illuminating an eye. In various implementations, a device includes a frame to mount the device to a head. The device includes a light source, coupled to the frame, to generate light. The device includes a waveguide, optically coupled to the light source, to redirect the light to emit in a first direction from a plurality of leakage points, wherein, when the device is mounted to the head, the light is emitted in the first direction towards the eye to illuminate the eye.

In various implementations, a method is performed at a at a device including frame, a light source, and a waveguide. The method includes mounting, using the frame, the device to a head. The method includes injecting light from the light source into the waveguide. The method includes illuminating an eye via emission of the light from a plurality of leakage points of the waveguide.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

In various implementations, to illuminate the eye of user for gaze tracking purposes, a plurality of light sources emits light from various locations to generate glints on the eye of the user. An image of the eye so illuminated can be analyzed to determine the gaze direction of the user. However, the user of a plurality of light sources can be costly, generate excess heat, and drain power. In various implementations, the plurality of light sources is replaced with a light source and a waveguide having a plurality of leakage points at which light generated by the light source is emitted to illuminate the eye of the user, e.g., generate glints upon the eye of the user.

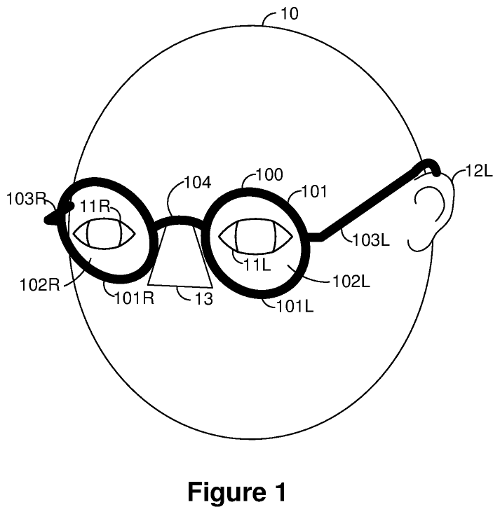

FIG. 1 illustrates a front view of glasses 100 worn by a user 10 according to various implementations. The glasses 100 include a frame 101. The frame 101 includes a left rim 101L and a right rim 101R coupled by a bridge 104. The frame 101 further includes a left temple 103L and a right temple 103R. The left rim 101L surrounds a left lens 102L and the right rim 101R surrounds a right lens 102R.

When worn as illustrated in FIG. 1, the left lens 102L is positioned in front of a left eye 11L of the user 10. In particular, the left lens 102L includes a first side and a second side, wherein the first side is closer to left eye 11L of the user 10 than is the second side. Similarly, the right lens 102R is positioned in front of a right eye 11R of the user 10. The right lens 102R includes a first side and second side, wherein the first side is closer to the right eye 11R of the user than is the second side.

When worn as illustrated in FIG. 1, the left temple 103L rests on a left ear 12L of the user 10 and the right temple 103R rests on a right ear (not shown) of the user 10. When worn as illustrated in FIG. 1, the bridge 104 rests on a nose 13 of the user.

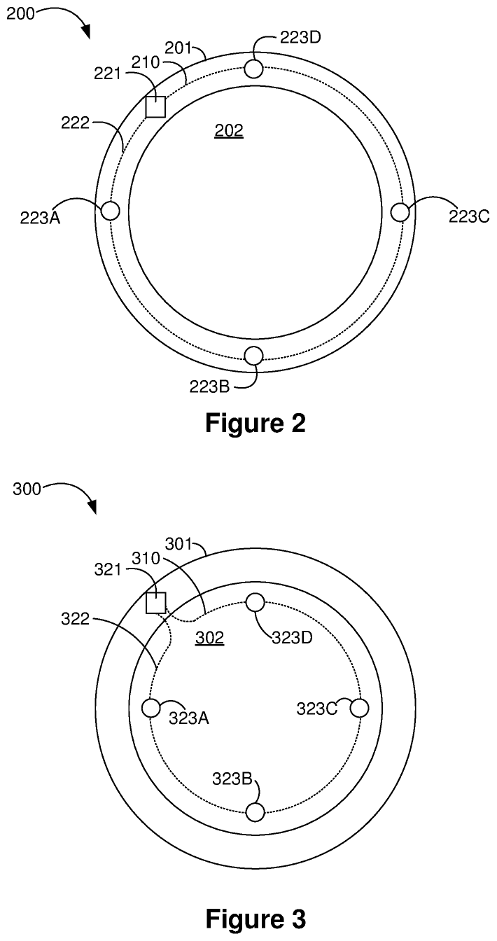

FIG. 2 illustrates a rear view of an eyepiece 200 including an illumination system 210 to illuminate the eye of a user according to a first implementation. The eyepiece 200 includes a rim 201 surrounding a lens 202. In various implementations, the eyepiece 200 is substituted for the left rim 101L and left lens 102L and/or the right rim 101R and right lens 102R of FIG. 1.

The illumination system 210 includes a light source 221 configured to generate light. In various implementations, the light source 221 generates infrared light. In various implementations, the light source 221 generates visible light. The illumination system 210 further includes a waveguide 222, optically coupled to the light source 221, to redirect the light such that light is emitted from a plurality of leakage points 223A-223D.

The light source 221 is attached to the rim 201 of the eyepiece 200. Further, the waveguide 222 is attached to the eyepiece 200 such that a majority of the waveguide 222 is attached to (e.g., embedded in) the rim 201 of the eyepiece 200 and each of the plurality of leakage points 223A-223D is at a location of the rim 201 of the eyepiece 200.

FIG. 3 illustrates a rear view of an eyepiece 300 including an illumination system 310 to illuminate the eye of a user according to a second implementation. The eyepiece 300 includes a rim 301 surrounding a lens 302. In various implementations, the eyepiece 300 is substituted for the left rim 101L and left lens 102L and/or the right rim 101R and right lens 102R of FIG. 1.

The illumination system 310 includes a light source 321 configured to generate light. In various implementations, the light source 321 generates infrared light. In various implementations, the light source 321 generates visible light. The illumination system 310 further includes a waveguide 322, optically coupled to the light source 321, to redirect the light such that light is emitted from a plurality of leakage points 323A-323D.

The light source 321 is attached to the rim 301 of the eyepiece 300. Further, the waveguide 322 is attached to the eyepiece 300 such that a majority of the waveguide 322 is attached to (e.g., embedded in) the lens 302 of the eyepiece 300 and each of the plurality of leakage points 323A-323D is at a location of the lens 302 of the eyepiece 300.

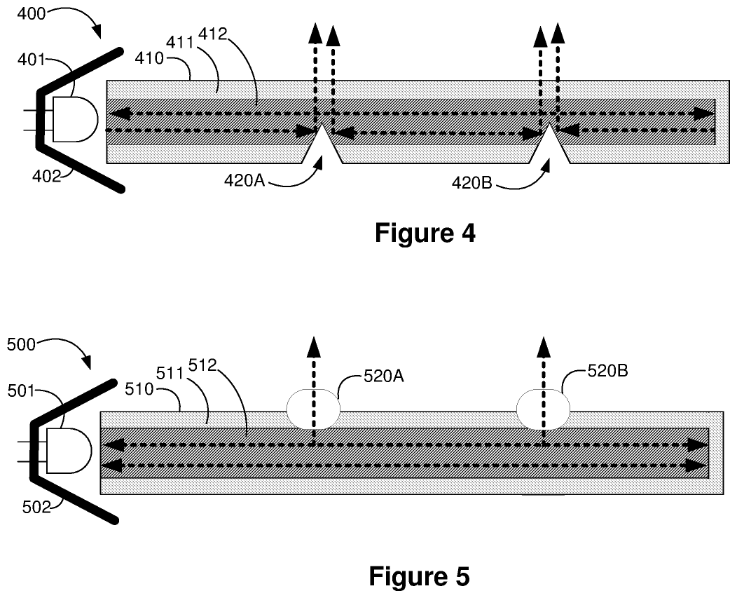

FIG. 4 illustrates a cross-sectional view of an illumination system 400 in accordance with a first implementation. The illumination system 400 includes a light source 401 coupled to a waveguide 410 by a coupler 402. In various implementations, the illumination system 400 is substituted for illumination system 210 of FIG. 2 or the illumination system 310 of FIG. 3.

In various implementations, the light source 401 includes one or more LEDs. In various implementations, the light source 401 includes one or more laser diodes. The waveguide 410 includes a core 412 surrounded by a cladding 411. In various implementations, the waveguide 410 has a circular cross-section. In various implementations, the core 412 has a first index of refraction and the cladding 411 has a second index of refraction lower than the first index of refraction such that the waveguide admits total internal reflection up to a critical angle. Although the waveguide 410 is illustrated as straight, the waveguide 410 can include curves and/or bends up to the critical angle.

The waveguide 410 includes a plurality of grooves 420A-420B in the waveguide, penetrating through the cladding 411 and into the core 412, each of the plurality of grooves 420A-420B acting as a leakage point at which light is emitted from the waveguide 410. FIG. 4 illustrates light as dashed arrows emitted from the light source 401 and undergoing total internal reflection within the core 412 of the waveguide 410, except for at the plurality of grooves 420A-420B at which the light is emitted.

FIG. 5 illustrates a cross-sectional view of an illumination system 500 in accordance with a second implementation. The illumination system 500 includes a light source 501 coupled to a waveguide 510 by a coupler 502. In various implementations, the illumination system 500 is substituted for illumination system 210 of FIG. 2 or the illumination system 310 of FIG. 3.

In various implementations, the light source 501 includes one or more LEDs. The waveguide 510 includes a core 512 surrounded by a cladding 511. In various implementations, the waveguide 510 has a circular cross-section. In various implementations, the core 512 has a first index of refraction and the cladding 511 has a second index of refraction lower than the first index of refraction such that the waveguide admits total internal reflection up to a critical angle. Although the waveguide 510 is illustrated as straight, the waveguide 510 can include curves and/or bends up to the critical angle.

The waveguide 510 includes a plurality of bubbles 520A-520B in the cladding 511, each of the plurality of bubbles 520A-520B acting as a leakage point at which light is emitted from the waveguide 510. In various implementations, the plurality of bubbles 520A-520B includes material having a third index of refraction different than the second index of refraction. FIG. 5 illustrates light as dashed arrows emitted from the light source 501 and undergoing total internal reflection within the core 512 of the waveguide 510, except for at the plurality of bubbles 520A-520B at which the light is emitted.

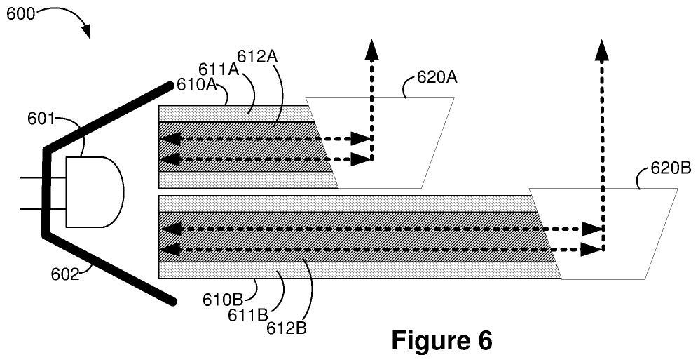

FIG. 6 illustrates a cross-sectional view of an illumination system 600 in accordance with a third implementation. The illumination system 600 includes a light source 601 coupled to a plurality of waveguides 610A-610B by a coupler 602. In various implementations, the illumination system 600 is substituted for illumination system 210 of FIG. 2 or the illumination system 310 of FIG. 3.

In various implementations, the light source 600 includes one or more LEDs. Each waveguide 610A-610B includes a core 612A-612B surrounded by a cladding 611A-611B. In various implementations, each waveguide 610A-610B has a circular cross-section. In various implementations, each core 612A-612B has a first index of refraction and each cladding 611A-611B has a second index of refraction lower than the first index of refraction such that the waveguide admits total internal reflection up to a critical angle. Although the waveguides 610A-610B are illustrated as straight, the waveguides 610A-610B can include curves and/or bends up to the critical angle.

Each waveguide 610A-610B terminates in a respective terminator 620A-620B, each of the plurality of terminators 620A-620B acting as a leakage point at which light is emitted from the waveguides 610A-610B. In various implementations, the plurality of terminators 620A-620B includes material having a third index of refraction different than the first index of refraction. In various implementations, the plurality of terminators 620A-620B includes a diffuse material. FIG. 6 illustrates light as dashed arrows emitted from the light source 601 and undergoing total internal reflection within the cores 612A-612B of the waveguides 610A-610B, except for at the plurality of terminators 620A-620B at which the light is emitted.

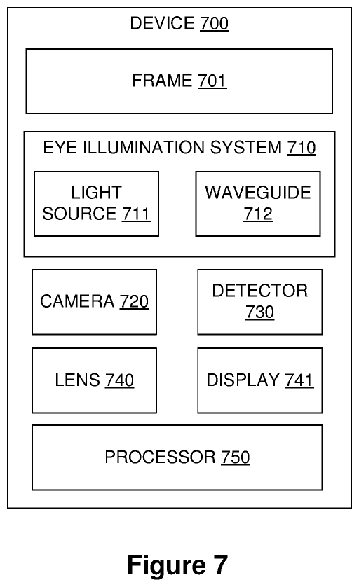

FIG. 7 illustrates a functional block diagram of a device 700 in accordance with some implementations. The device 700 includes a frame 701 to mount the device 700 to the head of a user. For example, FIG. 1 illustrates glasses 100 including a frame 101 to mount the glasses 100 to the head of the user 10.

The device 700 includes an eye illumination system 710 for illuminating at least one eye of the user when the device 700 to the head of the user. In various implementations, the eye illumination system 710 includes a light source 711 to generate light and a waveguide 712, optically coupled to the light source 711, to redirect the light to emit in a first direction at a plurality of leakage points. In various implementations, when the device 700 is mounted to the head of the user, the light is emitted in the first direction towards the eye of the user to illuminate the eye of the user.

For example, in FIG. 2, the eyepiece 200 includes a light source 221 and a waveguide 222 to emit light in a first direction (e.g., away from the page) at a plurality of leakage points 223A-223D. When the eyepiece 200 is substituted for the left rim 101L and left lens 102L of the glasses 100 of FIG. 1, the waveguide 222 emits light in a first direction towards the left eye 11L of the user 10.

As another example, in FIG. 3, the eyepiece 300 includes a light source 321 and a waveguide 322 to emit light in a first direction (e.g., away from the page) at a plurality of leakage points 323A-323D. When the eyepiece 300 is substituted for the left rim 101L and left lens 102L of the glasses 100 of FIG. 1, the waveguide 322 emits light in a first direction towards the left eye 11L of the user 10.

In various implementations, the light source 711 includes one or more LEDs. In various implementations, the light source 711 is to generate infrared light. In various implementations, the light source 711 is to generate visible light. In various implementations, the light source 711 is optically coupled to a first end of the waveguide and a second end of the waveguide. For example, in FIG. 2, the light source 221 is coupled to a first end of the waveguide 222 and a second end of the waveguide 222. Thus, light is injected into the waveguide 222 at both ends. As another example, in FIG. 3, the light source 321 is coupled to a first end of the waveguide 322 and a second end of the waveguide 322.

In various implementations, the waveguide 712 includes a core having a first index of refraction and a cladding having a second index of refraction less than the first index of refraction. In various implementations, the waveguide 712 is positioned in the first direction from the frame 701, e.g., between the frame 701 and the eye of the user when the device 700 is mounted to the head of the user. For example, in FIG. 2, the waveguide 222 is positioned in the first direction from the rim 201. In various implementations, the device 700 includes a lens 740 surrounded by the frame 701. For example, in FIG. 1, the glasses 100 includes a left lens 102L surrounded by the left rim 101L of the frame 100. In various implementations, the waveguide 712 is positioned in the first direction from the lens 740, e.g., between the lens 740 and the eye of the user when the device 700 is mounted to the head of the user. For example, in FIG. 3, the waveguide 322 is positioned in the first direction from the lens 302. In various implementations, the device 700 includes a display 741 surrounded by the frame 701. In various implementations, the display 741 emits visible light in the first direction in the form of images. In various implementations, the display 741 projects light onto the lens 740. In various implementations, the waveguide 712 is positioned in the first direction from the display 741, e.g., between the display 741 and the eye of the user when the device 700 is mounted to the head of the user.

Thus, in various implementations, the waveguide 712 lies substantially in a plane perpendicular to the first direction. In various implementations, the waveguide 712 includes a substantially circular portion with the plurality of leakage points spaced about the circular portion.

In various implementations, the waveguide 712 is sufficiently thin and, when the device 700 is mounted to the head of the user, sufficiently close to the eye of the user, that the waveguide 712 is imperceptible to the user.

In various implementations, the waveguide 712 includes a plurality of grooves respectively corresponding to the plurality of leakage points. For example, in FIG. 4, the waveguide 410 includes a plurality of grooves 420A-420B corresponding to a plurality of leakage points. In various implementations, the waveguide 712 includes a plurality of bubbles respectively corresponding to the plurality of leakage points. For example, in FIG. 5, the waveguide 510 includes a plurality of bubbles 520A-520B corresponding to a plurality of leakage points.

In various implementations, the waveguide 712 includes a plurality of fibers. In various implementations, each fiber includes a respective core having a first index of refraction and a respective cladding having a second index of refraction less than the first index of refraction. For example, in FIG. 6, the illumination system 600 includes a plurality of waveguides 610A-610B. In various implementations, each of the plurality of fibers terminates in a respective terminator corresponding to a respective one of the plurality of leakage points. For example, in FIG. 6, each of the plurality of waveguides 610A-610B terminates in a respective terminator 620A-620B corresponding to a respective one of the plurality of leakage points.

In various implementations, the device 700 further includes a detector 730 to detect an intensity of light. In various implementations, the light source 711 is optically coupled to a first end of the waveguide 712 and the detector 730 is optically coupled to a second end of the waveguide.

In various implementations, the device 700 further includes a camera 720 to capture a reflection of the light emitted in the first direction, e.g., an image of the eye of the user illuminated by the light emitted in the first direction when the device 700 is mounted to the head of the user.

In various implementations, the device 700 further includes a processor 750 to control various components of the device 700 and perform additional functions. For example, in various implementations, when the detector 730 detects an intensity of light over a threshold, the processor 750 reduces an intensity of the light generated by the light source to prevent overexposure of the eye of the user to infrared and/or visible light. As another example, in various implementations, the processor 750 analyzes an image of the eye of the user captured by the camera 720 to determine an identity of the user or determine a gaze direction of the user.

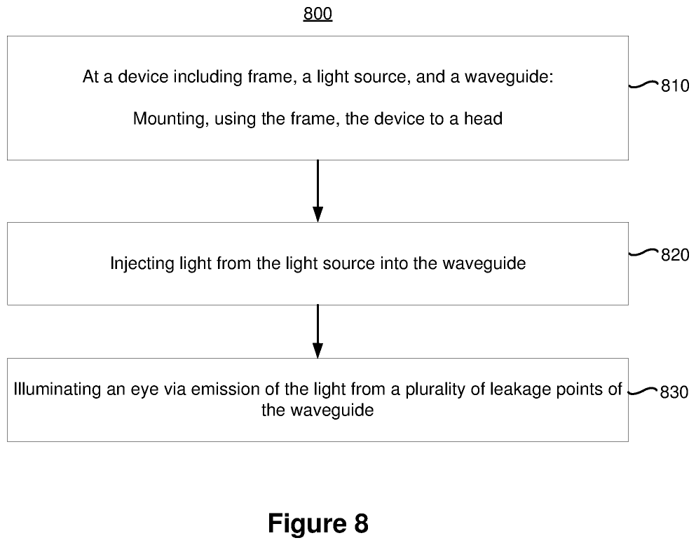

FIG. 8 is a flowchart representation of a method 800 of illuminating the eye of a user in accordance with some implementations. In various implementations, the method 800 is performed by a device including a frame, a light source, and a waveguide (e.g., the glasses 100 of FIG. 1 or the device 700 of FIG. 7). In some implementations, the method 800 is performed by processing logic, including hardware, firmware, software, or a combination thereof. In some implementations, the method 800 is performed by a processor executing instructions (e.g., code) stored in a non-transitory computer-readable medium (e.g., a memory).

The method 800 begins, in block 810, with mounting, using the frame, the device to an head. In various implementations, the frame includes temples and mounting the device to the head includes resting the temples on ears. In various implementations, the frame includes a bridge and mounting the device to the head includes resting the bridge on a nose. In various implementations, the frame includes one or more rims (which may each surround a lens and/or a display) and mounting the device to the head includes positioning a rim (and/or its surrounded lens and/or display) in front of the eye.

The method 800 continues, in block 820, with injecting light from the light source into the waveguide. In various implementations, injecting light from the light source into the waveguide includes powering or turning on the light source. In various implementations, the light source is optically coupled to the waveguide to inject light into the waveguide. In various implementations, the light source is optically coupled to each end of the waveguide to inject light into both ends of the waveguide.

The method 800 continues, in block 830, with illuminating an eye via emission of the light from a plurality of leakage points of the waveguide.

In various implementations, the method 800 further includes detecting an intensity of the emission of the light from the plurality of leakage points and adjusting an intensity of the light injected from the light source based on the detected intensity of the emission of the light from the plurality of leakage points. For example, if the intensity of the emission of the light from the plurality of leakage points is above a threshold, the intensity of the light injected from the light source may be reduced to prevent overexposure of the eye.

In various implementations, the method 800 further includes capturing an image of the eye illuminated via the emission of the light from the plurality of leakage points. In various implementations, the method 800 includes determining an identity based on the image or determining a gaze direction based on the image.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A device comprising:
a frame to mount the device to a head of a user;
a light source, coupled to the frame, to generate light;
a waveguide, optically coupled to the light source, to redirect the light to emit in a first direction from a plurality of leakage points, wherein, when the device is mounted to the head of the user, the light is emitted in the first direction towards an eye of the user to illuminate the eye of the user.

2. The device of claim 1, wherein the light source is to generate infrared light.

3. The device of claim 1, wherein the light source is to generate visible light.

4. The device of claim 1, wherein the light source is optically coupled to a first end of the waveguide and a second end of the waveguide.

5. The device of claim 1, wherein the waveguide is positioned in the first direction from the frame.

6. The device of claim 1, further comprising a lens surrounded by the frame.

7. The method device of claim 6, wherein the waveguide is positioned in the first direction from the lens.

8. The device of claim 1, further comprising a display surrounded by the frame.

9. The device of claim 8, wherein the waveguide is positioned in the first direction from the lens.

10. The device of claim 1, wherein the waveguide includes a plurality of grooves respectively corresponding to the plurality of leakage points.

11. The device of claim 1, wherein the waveguide includes a plurality of bubbles respectively corresponding to the plurality of leakage points.

12. The device of claim 1, wherein the waveguide includes a plurality of fibers.

13. The device of claim 12, wherein each of the plurality of fibers terminates in a respective terminator corresponding to a respective one of the plurality of leakage points.

14. The device of claim 1, further comprising a detector to detect an intensity of light, wherein the light source is optically coupled to a first end of the waveguide and the detector is optically coupled to a second end of the waveguide.

15. The device of claim 1, further comprising a camera to capture a reflection of the light emitted in the first direction.

16. A method comprising:
at a device including a frame, a light source, and a waveguide:
mounting, using the frame, the device to a head of a user;
injecting light from the light source into the waveguide; and
illuminating an eye of the user via emission of the light from a plurality of leakage points of the waveguide.

17. The method of claim 16, wherein mounting the device to the head of the user includes resting temples of the frame on ears of the user.

18. The method of claim 16, wherein mounting the device to the head of the user includes resting a bridge of the frame on a nose of the user.

19. The method of claim 16, wherein mounting the device to the head of the user includes positioning an eyepiece of the frame in front of the eye of the user.

20. The method of claim 16, further comprising:
detecting an intensity of the emission of the light from the plurality of leakage points; and
adjusting an intensity of the light injected from the light source based on the detected intensity of the emission of the light from the plurality of leakage points.

21. The method of claim 16, further comprising capturing an image of the eye of the user illuminated via the emission of the light from the plurality of leakage points.

22. The method of claim 21, further comprising determining an identity of the user based on the image of the eye of the user.

23. The method of claim 21, further comprising determining a gaze direction of the user based on the image of the eye of the user.
